(19) United States
(12) Patent Application Publication
(10) Pub. No.: US 2023/0408344 A1
(43) Pub. Date: Dec. 21, 2023

(54) METHOD FOR ASCERTAINING A CABLE TEMPERATURE AND/OR CONNECTOR TEMPERATURE ON AN ELECTRIC DRIVE

(71) Applicant: Robert Bosch GmbH, Stuttgart (DE)

(72) Inventors: Klaus Ries-Mueller, Bad Rappenau (DE); Peter Feuerstack, Ludwigsburg (DE)

(21) Appl. No.: 18/254,695

(22) PCT Filed: Nov. 17, 2021
(86) PCT No.: PCT/EP2021/081931

§ 371 Date: May 26, 2023

(30) Foreign Application Priority Data
Dec. 3, 2020 (DE) 10 2020 215 326.4

(51) Int. Cl. G01K 7/16; G01K 3/00; H01M 10/48; H01M 10/42

(52) U.S. Cl. CPC G01K 7/16; G01K 3/005; H01M 10/48; H01M 10/425; B60L 58/10

(57) ABSTRACT

The invention relates to a method for ascertaining a cable temperature and/or connector temperature on an electric drive having an e-axle module (32) with an electric machine (30), a power electronics system (18), and a DC voltage source (16), in particular a high-voltage battery (10), which are connected together via a connection cable (36), at least the following method steps being carried out:

A voltage U_Batt voltage is measured at a DC voltage source (16) and a voltage U_INV is measured at an input of the power electronics system (18). Measurement accuracy is subsequently compared by referencing U_INV to U_Batt. This is followed by determining a reference sum resistance R_sum_ref of the connection cable (36) at a known temperature T_{ref}. Then, with current flowing between the DC voltage source (16) and the power electronics system (18), a difference U_delta between the voltage U_Batt of the DC voltage source (16) and the voltage U_INV at an input of the power electronics system (18) is measured and the sum resistance R_sum is determined. Then, the temperature is determined from repeated determination of the sum resistance R_Sum during operation and the temperature of the connection cable (36), the connections and connecting elements, such as plugs, is calculated. This is followed by a differentiation between the resistances R₁ of a connection (12, 14) of the DC voltage source (16), and/or a resistance R₂ of a connection cable (36), and/or a resistance R₃ of an input of the power electronics system (18). Subsequently, a drive power of the electric drive is reduced, while the temperature of the connections (12, 14), the connection cable (36) and the at least one input of the power electronics system (18) exceeds a temperature threshold.

The invention further relates to the use of the method to ascertain the temperature of a connection cable (36) for connection terminals (12, 14) of a DC voltage source (16) and the temperature at least one input of a power electronics system (18) of an e-axle module (32) of an electrically powered vehicle.

### BACKGROUND

The invention relates to a method for ascertaining a cable temperature and/or connector temperature on an electric drive having an e-axle module with an electric machine, a power electronics system, and a DC voltage source, in particular a high-voltage battery, which are connected to each other via connection cables. The invention further relates to the use of the method to ascertain the temperature of a connection cable for connection terminals of a DC voltage source or the temperature of at least one input of a power electronics system of an e-axle module of an electrically driven vehicle.

In the future, it is expected that vehicles with electric motors, whether electric vehicles or hybrid vehicles, will increasingly be used in road transport. An essential component of electric drives is the power electronics system, which converts the DC voltage of the battery into an AC voltage for the electric machine. In the future, the power electronics system will be mounted directly in or on the electric machine, thus being able to omit cables and connectors as well as other small connection parts, etc. Preferably, the electric machine, a transmission, and the power electronics system are combined to form an electric drive axis, which is also referred to as the e-axle module. The e-axle module is then only electrically connected to the battery, usually a DC voltage source designed as a high-voltage battery.

The current conduction from the DC voltage source, i.e., the high-voltage battery, to the power electronics system and an inverter included therein for converting the DC voltage into an AC voltage typically flows via a connection cable with a relatively large conductive cross-section, which is typically manufactured from copper or a copper alloy. These are attached to the inverter with plug or screw connectors.

The connection cables and the connections on the inverter of the power electronics system heat up at high currents. In order to protect temperature-sensitive components within the inverter (e.g., capacitors), the inverter input or an inverter bus has conventionally been cooled in a complex manner. In order reduce the temperature load, the option also exists of increasing the copper cross-section of the connection cables so as to reduce the electrical resistance and adjusting the heating thereby. However, this solution is associated with relatively high costs and additional space requirements.

Under some circumstances, a reduction in the requested power may be required prior to exceeding temperature thresholds, which is also referred to as “derating” (a forced reduction in drive power). Said temperature thresholds are determined during the application phase on some vehicles equipped with temperature sensors at the corresponding electrical loads, which are dependent on the currents occurring during the phases, etc. Typically, these critical current thresholds are permanently stored in the battery control unit of production vehicles.

### SUMMARY

Proposed according to the invention is a method for ascertaining a cable and/or connector temperature in an electric drive with an e-axle module comprising an electric machine and a power electronics system, as well as a DC voltage source, in particular a high-voltage battery, which are connected to one another via connection cables, since at least the following method steps are carried out:
measuring a voltage U_Batt at a DC voltage source and measuring a voltage U_INV at an input of the power electronics system,
comparing a measurement accuracy in relation to U_INV and U_Batt,
determining a reference sum resistance R_sum_ref for the connection cable at a known temperature T_{ref},
with current flowing between the DC voltage source and the power electronics system, a difference U_delta between the voltage U_Batt of the DC voltage source and the voltage U_INV at an input of the power electronics system is measured and the sum resistance R_sum is determined.
determining the temperature obtained from repeated determination of the sum resistance during operation and calculating an average temperature of the connection cable and connecting elements.
differentiating between the resistances R₁ of a connector or a connection element of the DC voltage source, a resistance R₂ of a connection cable, and a resistance R₃ of a connector of the power electronics system, and
reducing a drive power of the electric drive when exceeding a threshold temperature value via the temperature of the connectors, a connection cable, and at least one input of the power electronics system.

The solution proposed according to the invention can advantageously reduce the tolerance behavior achieved thus far in order to advantageously determine the temperature in a significantly more precise manner, thus significantly increasing the drive power of the power electronics system, in particular the integrated inverter therein, especially during continuous operation of an e-axle module.

In one advantageous embodiment of the method proposed according to the invention, the voltage values measured according to a) are detected in at least one battery control unit and in the power electronics system.

In a further embodiment of the method proposed according to the present invention, according to b) a reference is generated when the vehicle is being started with no power flow to the power electronics system and repeated cyclically, or reference generation takes place based on an average generated over multiple measurements.

Both methods can achieve a comparison of a measurement accuracy, which again improves the “derating” in terms of reliability and helps to reduce the specified tolerance.

In one advantageous embodiment of the method proposed according to the invention, a determination of the reference sum resistance is, according to c), performed immediately after start-up at a stable vehicle temperature by means of temperature sensors provided in the power electronics system while taking into account the resistance determination in step d).

In one advantageous method step of the method proposed according to the invention, the reference values are determined at cyclic intervals at the same temperature of all components.

In the method proposed according to the invention, the following procedure is used to determine the sum resistance R_sum:

$$\begin{matrix}U\_Batt - U\_INV = U\_delta with \\ U\_delta = ( {R}_{1} + {R}_{2} + {R}_{3} ) * I\_DC = R\_sum * I\_DC to \\ R\_sum = \frac{U\_delta}{I\_DC}\end{matrix} .$$

In the method proposed according to the invention, the determination of the resistance R_sum according to d) is performed repeatedly during operation, and a temperature determination of the connection cable is performed using temperature coefficients for the conduction material used in the connection cable.

In the method proposed according to the invention, a differentiation between the resistances R₁, R₂, and R₃ can be made in an advantageous manner according to f) and based on the various heat capacities C_{P,i} of said materials in order to achieve improvement of the data obtained.

In the method proposed according to the invention, monitoring of a temperature change over the vehicle life is performed, and in particular an alert is issued when an increasing contact resistance is detected at one of the connectors or at an input of the power electronics system.

The method proposed according to the invention is preferably used for ascertaining the temperature of a connection cable of a terminal for a DC voltage source, in particular a high-voltage battery, or at least one input of a power electronics system of an e-axle module in an electrically driven vehicle.

Regarding the solution proposed according to the invention, the temperature of the connection cable between the high-voltage battery and the inverter of the power electronics system and the inverter connectors can be determined very precisely by means of a voltage measurement or a resistance measurement. By means of the solution proposed according to the invention, a significantly more precise “derating” can be achieved by ascertaining the cable temperature or the temperature of the connectors involved. By reducing the tolerance behavior achievable using the solution proposed according to the invention, the specified drive power of an e-axle module of an electrically driven vehicle, which is controlled by the inverter of the power electronics system, can be significantly increased, particularly during continuous operation of the electric machine.

Since a reduction of the tolerance behavior is achievable using the solution proposed according to the invention, costs can be saved due to the improved data, e.g., by reducing the cable cross section of the electrical connection cables between the DC voltage source and the inverter, which have conventionally been oversized, which is disadvantageous for cost and weight. It should be noted that, in order to perform the method proposed according to the invention, the previously existing sensors, e.g., a battery management system, can be used for battery voltage measurement, and no additional components resulting in additional costs need to be used. The method proposed according to the invention also increases safety, because, e.g., an increase in the contact resistances of the connecting elements, and thus an undesirable temperature increase at this contact position, can be detected in a timely manner.

### BRIEF DESCRIPTION OF THE DRAWINGS

The invention will be described in greater detail hereinafter in reference to the drawings:

Shown are:

FIG. 1 the essential components of an electric drive system,

FIG. 2 an illustration of an e-axle module,

FIG. 3 an equivalent circuit diagram for the following components: battery connector, connection cable, and connector power electronics system or inverter,

FIG. 4 an equivalent circuit diagram regarding the thermal heat capacity of the battery connection cable and the inverter or power electronics connector,

FIGS. 5.1 and 5.2 resistance and temperature profiles of connections and cables, each plotted across the time axis.

FIG. 6 graph of copper (Cu) resistance as a function of copper temperature.

### DETAILED DESCRIPTION

In the following description of the embodiments of the invention, identical or similar elements are indicated by identical reference signs, thus avoiding a repeated description of these elements in individual cases. The drawings illustrate the subject matter of the invention in a schematic manner only.

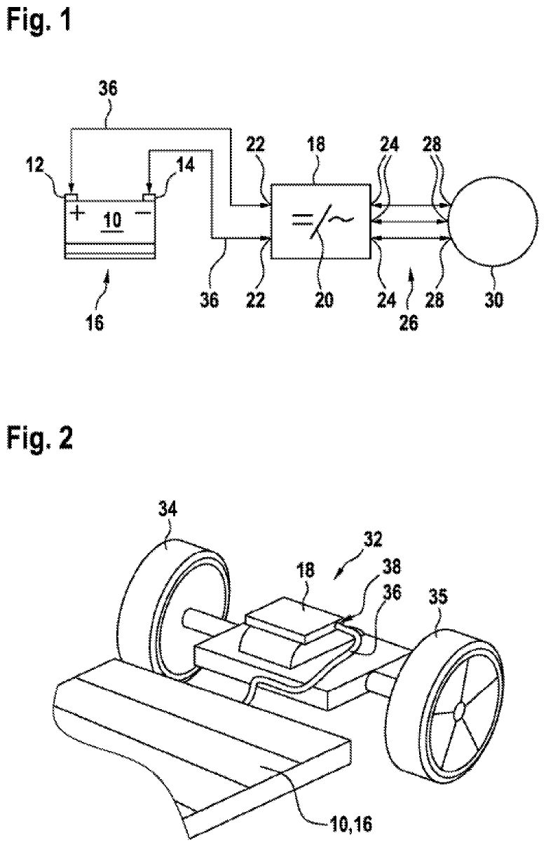

FIG. 1 shows essential components of an electric drive. A DC voltage source 16 is designed as a high-voltage battery 10 having a second terminal 14. A two-core connection cable 36 or two parallel connection cables 36 are used to connect the first terminal 12 and the second terminal 14 of the high-voltage battery 10 to DC inputs 22 of an inverter 20, which is part of a power electronics system 18. In the inverter 20, the DC voltage of the DC voltage source 16 is converted into an AC voltage, which is supplied to a three-phase 28-current system 26 at an AC current output 24 of the power electronics system 18. An electric machine 30 operates via the three phases 28 of the AC system 26.

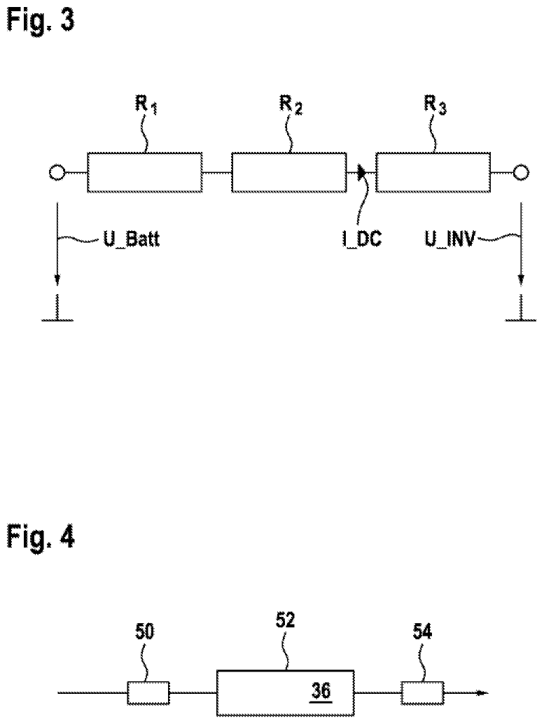

FIG. 2 shows an e-axle module 32 comprising a power electronics system 18 located on the upper side of the e-axle module 32. A first driven wheel 34 and a second driven wheel 35 are driven thereby. The DC voltage source 16, which is designed as a high-voltage battery 10, is connected to a connector 38 of the power electronics system 18 via the connection cables 36. The connector 38 can be either a screw connector 40 or a plug connector 42.

Whereas an equivalent circuit diagram of the electrical resistance R is shown in FIG. 3, FIG. 4 shows an equivalent circuit diagram of the system with respect to the thermal heat capacity c_{b}.

In the electrical equivalent circuit diagram shown in FIG. 3, R₁ indicates the resistance of the connectors of the high-voltage battery 10, R₂ indicates the resistance of the connection cable 36, and R₃ indicates the resistance at the inputs 22 to the inverter 20, which is part of the power electronics system 18. Also illustrated are the battery voltage U_Batt and the current flowing in the system I_DC, as well as the voltage drop at the inverter input U_INV. With respect to heat capacity c_{b}, the equivalent circuit diagram in FIG. 4 shows that a first heat capacity 50 of the terminals 12, 14 of the high-voltage battery 10 substantially corresponds to a third heat capacity 54 at the DC input 22 of the inverter 20 of the power electronics system 18, while a second (substantially higher) heat capacity 52 is provided by the connection cable 36 or its conductive material. This relationship can be gathered from the thermal equivalent circuit diagram shown in FIG. 4.

In the method proposed according to the invention, one voltage is measured at the high-voltage battery 10 U_Batt, and one voltage is measured at the inverter input (i.e., at the input of the inverter 20 of the power electronics system U_INV) at a current I_DC=0. The voltage values are sensed separately in at least one battery control unit and in the inverter 20 of the power electronics system 18.

The measurement accuracy is compared by, e.g., using the voltage U_Batt as a reference. The voltage at the inverter input U_INV is referenced or corrected to this value. The same voltage is measured in both measurement methods. Such a reference can, e.g., be generated when the vehicle is being started with no current flow to the inverter 20 and can be repeated cyclically. It may be advisable to obtain a mean of multiple measurements.

A determination of a reference conduction resistance U_ref is performed at a known temperature T_{ref}. This measurement can either be performed during the manufacturing process and the corresponding readings can be stored, or it is also possible to store the measurement of these values directly after initial start-up at a stable vehicle temperature with the aid of existing temperature sensors, which can be installed, e.g., in the inverter 20 of the power electronics system 18. In this context, a resistance determination is performed which is described hereinafter.

Optionally, the determination of the reference values specified hereinabove can also be repeated at any time, provided that it is ensured that all components are at the same temperature during the reference determination, as is the case after, e.g., a longer vehicle stoppage.

When power flows between the high-voltage battery 10 and the inverter 20 of the power electronics system 18, a differential voltage U_delta is measured between the voltage at the battery U_Batt and the voltage at the inverter 20 of the power electronics system 18, and a determination of the sum resistance is performed according to the following relation:

U_Batt−U_INV=U_delta.

U_delta=(R₁+R₂+R₃)*I_DC=R_sum*I_DC.

Since the difference after voltage difference U_delta and I_DC are known and can be obtained from a current measurement within the high-voltage battery 10, the sum resistance R_sum can be calculated.

In the method proposed according to the invention, the temperature of the connection cable 36 is determined given the assumption that the temperature of the connection cable 36 is proportional to the electrical resistance. This means that the temperature can be determined from the electrical resistance R. To this end, a resistance determination is made according to the above relation for R_sum and performed repeatedly during operation. The temperature of the connecting line, i.e., the connection cable 36, is respectively calculated using the temperature coefficient of the conduction material. For example, the temperature coefficient for the substance copper (Cu) is 3.39*10⁻³/Kelvin, and it is 4.0*10⁻³/Kelvin for aluminum.

The following rough estimate results:

$${R}_{D C} ( T ) \approx {R}_{D C} * ( 1 + \frac{0.4 \%}{K} * ( T - {T}_{0} ) ) = {R}_{D C} + Δ {R}_{D C} ( T )$$

The following rough estimate is obtained on this basis:

$$Δ {R}_{D C} ( T ) \approx {R}_{D C} * \frac{0.4 \%}{K} * ( T - {T}_{0} )$$

T, T₀: Temperature, reference temperature

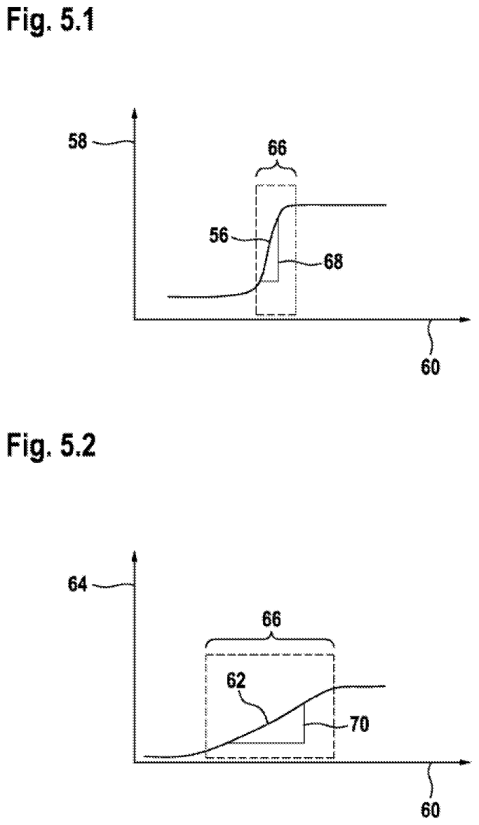

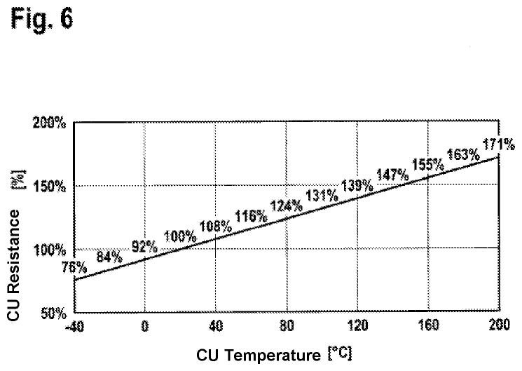

Finally, in the method proposed according to the invention, a distinction is made between the resistances R₁ and R₂ given their differing heat capacities. The connectors, both terminals 12, 14 of the high-voltage battery 10, and the connectors at the DC input 22 of the inverter 20 of the power electronics system 18 exhibit significantly higher dynamics with respect to changes in resistance than in the dynamics occurring in the connection cable 36. These relationships are compared to one another in FIGS. 5.1 and 5.2.

In the illustration shown in FIG. 5.1, a resistance or temperature profile 56 of the connectors is plotted across a time axis 60. In the illustration shown in FIG. 5.2, a resistance curve or temperature curve in the connection cable 36 is plotted across the time axis 60. Gradients can be determined within the transition area 66 shown in both FIGS. 5.1 and 5.2. For example, a first gradient 68 is made much steeper in terms of the change in resistance and temperature at the connectors than a second gradient 70, which has a flatter profile that is located within the connection cable 36 between the high-voltage battery 10 and a DC input 22 of the inverter 20 of the power electronics system 18.

In the method proposed according to the invention, a threshold value can be defined according to the temperature determined for the connections or the connection cable 36. If the temperature of the connections 12, 14 or the DC input 22 or the temperature of the connection cable 36 exceeds the threshold value, then the drive power and thus the I_DC current is reduced.

When observing the change in temperature as viewed over the vehicle life, a gradually adjusting occurrence of damage can optionally be detected. If, for example, the temperature of the connections 12, 14 increases over the service life, an increasing contact resistance can be assumed and, if necessary, a warning or a maintenance note can be provided to the vehicle owner or the driver.

The invention is not limited to the exemplary embodiments described herein and the aspects emphasized thereby. Rather, a variety of modifications, which are within the scope of activities of the skilled person, is possible within the range specified by the claims.

1. A method for ascertaining a cable temperature and/or connector temperature on an electric drive having an e-axis module (32) with an electric machine (30), a power electronics system (18) and a DC voltage source (16), which are connected to each other via a connection cable (36), the method comprising:
a) a voltage U_Batt is measured at a DC voltage source (16) and a voltage U_INV is measured at an input of the power electronics system (18),
b) measurement accuracy is subsequently compared by referencing U_INV to U_Batt,
c) determining a reference sum resistance R_sum_ref at a known temperature T_{ref},
d) with current flowing between the DC voltage source (16) and the power electronics system (18), a difference U_delta between the voltage U_Batt of the DC voltage source (16) and the voltage U_INV at an input of the power electronics system (18) is measured and the sum resistance R_sum is determined,
e) determining the temperature from repeated determination of the sum resistance during operation and calculating an average temperature of the connection cable (36),
f) differentiating between the resistance R₁ of a connector (12, 14) of the DC voltage source (16), a resistance R₂ of a connection cable (36), and a resistance R₃ of a connector of the power electronics system (18), and
g) reducing a drive power of the electric drive when exceeding a threshold temperature value via the temperature of the connectors (12, 14), the connection cable (36), and/or the input of the power electronics system (18).

2. The method according to claim 1, wherein the voltage values measured in step a) are detected in a battery control unit and in the power electronics system (18).

3. The method according to claim 1, wherein, according to b), a reference is generated when the vehicle is started with no current flow to the power electronics system (18) and is repeated cyclically,
or
a reference is generated based on obtaining a mean via a plurality of measurements.

4. The method according to claim 1, wherein, according to c), a determination of the reference sum resistance is performed immediately after initial start-up at a stable vehicle temperature by means of temperature sensors provided in the power electronics system (18), taking into account the resistance measurement according to d).

5. The method according to claim 1, wherein, a determination of the reference values is performed at cyclic intervals at the same temperature for all components.

6. The method according to claim 1, wherein the determination of a conductive resistance R_sum is performed as
$$\begin{matrix}follows : U\_Batt - U\_INV = U\_delta with \\ U\_delta = ( {R}_{1} + {R}_{2} + {R}_{3} ) * I\_DC = R\_sum * I\_DC , to \\ R\_sum = \frac{U\_delta}{I\_DC}\end{matrix}$$

7. The method according to claim 1, wherein the determination of the resistance R_sum according to d) is performed repeatedly during operation, and a temperature calculation of the connection cable (36) is performed using the temperature coefficient for the conductive material which the leads of the connection cable (36) are made of.

8. The method according to claim 1, wherein
, according to f), a differentiation between the resistances R₁, R₂, and R₃ is made based on the various heat capacities c_{P} of their materials.

9. The method according to claim 1, wherein a monitoring of a temperature change over the vehicle life is performed and, if an increasing contact resistance is detected, an alert is output at one of the connectors (12, 14) or at an input of the power electronics system (18).

10. A method for ascertaining the temperature of a connection cable (36), the terminals (12, 14) of a DC voltage source (16), and/or at least one input of a power electronics system (18) of an e-axle module (32) in an electrically driven vehicle, the method comprising:
a) measuring a voltage U_Batt at a DC voltage source (16) and measuring a voltage U_INV at an input of the power electronics system (18),
b) subsequently comparing measurement accuracy by referencing U_INV to U_Batt,
c) determining a reference sum resistance R_sum_ref at a known temperature T_{ref},
d) with current flowing between the DC voltage source (16) and the power electronics system (18), measuring a difference U_delta between the voltage U_Batt of the DC voltage source (16) and the voltage U_INV at an input of the power electronics system (18) and determining the sum resistance R_sum,
e) determining the temperature from repeated determination of the sum resistance during operation and calculating an average temperature of the connection cable (36),
f) differentiating between the resistance R₁ of a connector (12, 14) of the DC voltage source (16), a resistance R₂ of a connection cable (36), and a resistance R₃ of a connector of the power electronics system (18), and
g) reducing a drive power of the electric drive when exceeding a threshold temperature value via the temperature of the connectors (12, 14), the connection cable (36), and/or the input of the power electronics system (18).
